(19) United States
(12) Patent Application Publication
(10) Pub. No.: US 2009/0327674 A1
(43) Pub. Date: Dec. 31, 2009

(54) Loop Control System and Method

(75) Inventors: Lucian Codrescu, Austin, TX (US); Erich James Plondke, Austin, TX (US); Lin Wang, Austin, TX (US); Suresh K. Venkumahanti, Austin, TX (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/147,893

(22) Filed: Jun. 27, 2008

(51) Int. Cl. G06F 9/30

(52) U.S. Cl. 712/241; 712/E09.016

(57) ABSTRACT

Loop control systems and methods are disclosed. In a particular embodiment, a hardware loop control logic circuit includes a detection unit to detect an end of loop indicator of a program loop. The hardware loop control logic circuit also includes a decrement unit to decrement a loop count and to decrement a predicate trigger counter. The hardware loop control logic circuit further includes a comparison unit to compare the predicate trigger counter to a reference to determine when to set a predicate value.

### I. FIELD

The present disclosure is generally related to loop control systems and methods.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable computing devices, such as cellular telephones and IP telephones, can communicate voice and data packets over wireless networks. Further, many such portable wireless devices also incorporate other types of devices. For example, a wireless telephone can also include a digital still camera, a digital video camera, a digital recorder, and an audio file player. Also, such wireless telephones can process executable instructions, including software applications, such as a web browser application that can be used to access the Internet. As such, these wireless telephones can include significant computing capabilities.

Executable instructions repeated within a software application may be executed by a processor as a software pipelined loop. Software pipelining is a method for scheduling non-dependent instructions from different logical iterations of a program loop to execute concurrently. Overlapping instructions from different logical iterations of the loop increases an amount of parallelism for efficient processing. For example, a first loop instruction and a second loop instruction may be executed in parallel at separate execution units of a processor in a computing device such as a wireless mobile device, the first instruction corresponding to a first loop iteration while the second instruction corresponds to a second loop iteration. Although such software pipelined loops may be executed more efficiently than non-pipelined loops, additional instructions to prevent data hazards due to data dependencies between instructions when filling the pipeline (e.g., prolog instructions) and to prevent memory access hazards when emptying the pipeline (e.g., epilog instructions) may increase an amount of memory required to execute an application. Such additional memory may not be readily available at a wireless computing device.

### III. SUMMARY

In a particular embodiment, a system is disclosed that includes a hardware loop control logic circuit. The hardware loop control logic circuit includes a detection unit to detect an end of loop indicator of a program loop, a decrement unit to decrement a loop count and to decrement a predicate trigger counter, and a comparison unit to compare the predicate trigger counter to a reference to determine when to set a predicate value. The system also includes a processor that executes a special instruction that triggers execution of the hardware loop control logic circuit. Use of the system with the hardware loop control logic circuit enables software pipeline loops to be executed without prolog instructions, thereby using reduced memory.

In another particular embodiment, an apparatus is disclosed that includes a predicate count register to store a predicate trigger count. The apparatus also includes an initialization logic circuit to initialize loop parameters of a program loop. The apparatus includes a processor to execute loop instructions of the program loop and to execute a packet including an end of loop indicator. The apparatus also includes a logic circuit to modify the predicate trigger count and to modify a loop count of the program loop. The apparatus also includes a comparison logic circuit to compare the predicate trigger count to a reference value. The apparatus further includes a logic circuit to change a value of a predicate that affects at least one instruction in the program loop based on a result of the comparison.

In another particular embodiment, a method of processing loop instructions is disclosed. The method includes initializing loop parameters in special registers where the special registers include a predicate trigger count. The method also includes executing the loop instructions and executing a packet having an end of loop indicator. The method further includes modifying the predicate trigger count and modifying a loop count. When the predicate trigger count equals a reference value, the method includes changing a value of a predicate that affects at least one of the loop instructions.

In another particular embodiment, a method of processing a set of instructions in a loop is disclosed. The method includes automatically initializing a predicate trigger counter to indicate a number of iterations of the loop to execute before setting a predicate value upon execution of a particular type of loop instruction. The method also includes executing the set of instructions during a loop iteration and, upon detecting an end of loop indicator of the loop, automatically triggering loop control hardware to modify the predicate trigger counter and to compare the predicate trigger counter to a reference to determine when to set the predicate value. At least one of the instructions in the set of instructions is conditionally executed based on the predicate value.

One particular advantage provided by at least one of the disclosed embodiments is reduced code size, lower power operation, and higher speed processing of instructions that are executed as pipelined software loops. Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a first illustrative embodiment of a loop control system;

FIG. 2 is a block diagram of a second illustrative embodiment of a loop control system;

FIG. 3 is a general diagram that illustrates processing of a software pipelined loop;

FIG. 4 is a flow chart of a first illustrative embodiment of a loop control method that may be performed by the loop control system of FIG. 1 or FIG. 2;

FIG. 5 is a flow chart of a second illustrative embodiment of a loop control method that may be performed by the loop control system of FIG. 1 or FIG. 2; and

FIG. 6 is a block diagram of a particular illustrative embodiment of a wireless processing device including a software pipelined loop hardware control logic circuit with a predicate counter.

### V. DETAILED DESCRIPTION

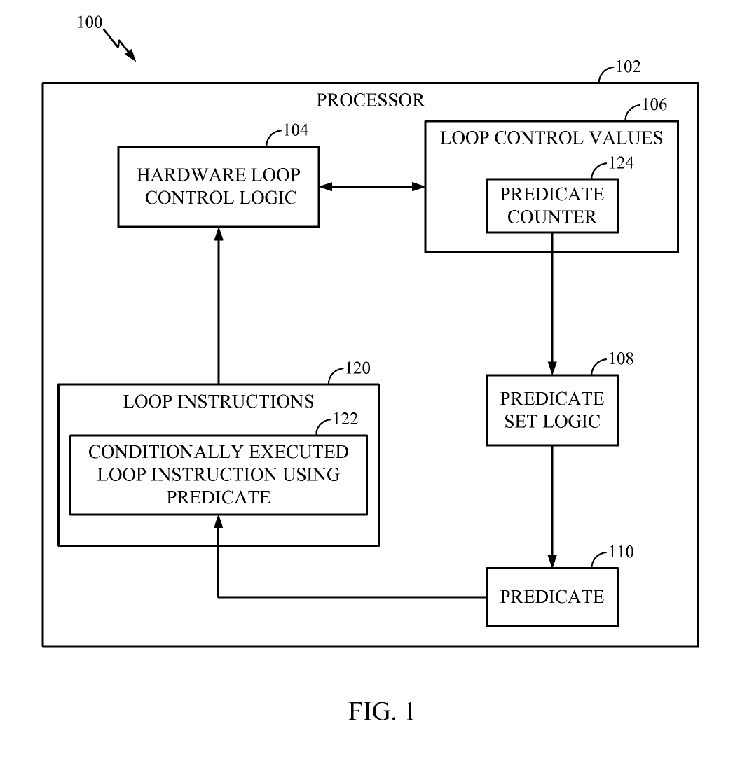

Referring to FIG. 1, a first illustrative embodiment of a loop control system is depicted and generally designated 100. The system 100 may be part of computer, a portable wireless device, a wireless telephone, or any other device that executes software instructions. The system 100 includes a processor 102 with a hardware loop control logic circuit 104.

The processor 102 is configured to execute loop instructions 120. The loop instructions 120 include at least one conditionally executed loop instruction 122 that uses a predicate logic circuit 110. For example, the conditionally executed loop instruction 122 may be executed by the processor 102 when the predicate logic circuit 110 stores a predicate value evaluating to true, and the conditionally executed loop instruction 122 may not be executed when the predicate logic circuit 110 stores a predicate value evaluating to false. Executing the loop instructions 120 enables the processor 102 to efficiently perform repeated operations, such as for a multimedia software application or a digital signal processing operation, for example.

Loop control values 106 are accessible to the hardware loop control logic circuit 104 and to a predicate set logic circuit 108. The predicate set logic circuit 108 is coupled to the predicate logic circuit 110. In a particular embodiment, the predicate logic circuit 110 may include a latch or other storage device adapted to store a data bit having a false value (e.g., a logical “0” value) or a true value (e.g., a logical “1” value). By using the hardware loop control logic circuit 104 and the predicate set logic circuit 108, software pipelined loops may be encoded in a compact form where pipelined loop stages used to initialize a software pipeline may be replaced with one or more conditionally executed loop instructions working in conjunction with the hardware loop control logic circuit 104 of the system 100, as will be described below.

In a particular embodiment, the hardware loop control logic circuit 104 includes circuitry that is adapted to recognize a beginning of a software loop corresponding to the loop instructions 120. The hardware loop control logic circuit 104 may be adapted to initially set and to modify the loop control values 106 to initialize and control execution of the loop instructions 120 by the processor 102. In particular, the hardware loop control logic circuit 104 is adapted to initialize a predicate counter 124 of the loop control values 106. In addition to the predicate counter 124, the loop control values 106 may include other values to control an operation of a loop, such as a loop start address and a number of loop iterations, as illustrative examples.

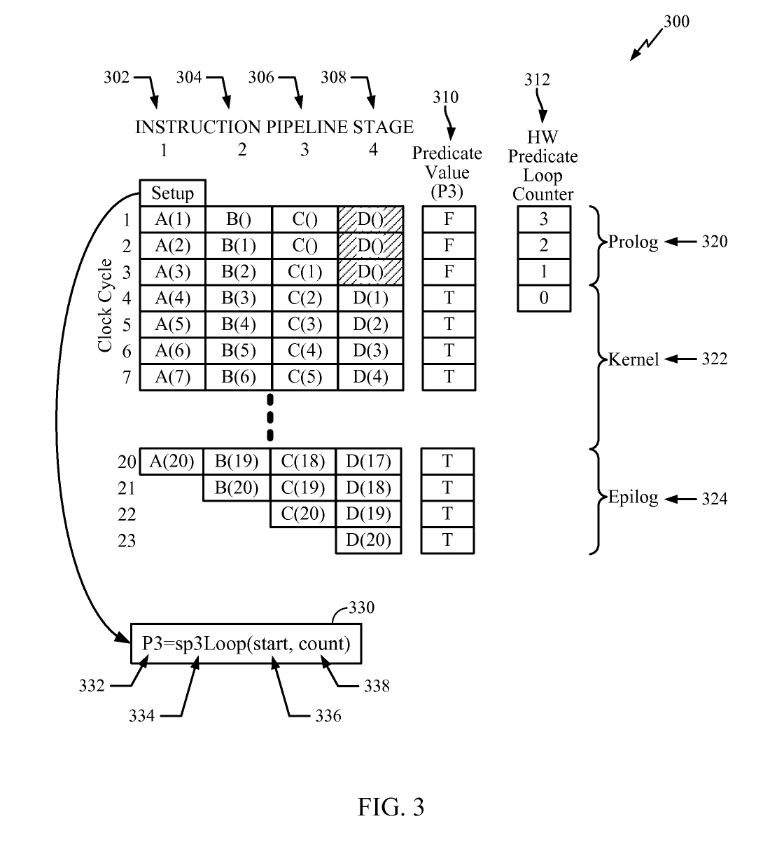

The predicate counter 124 may be initialized by the hardware loop control logic circuit 104 to a value corresponding to a number of processing cycles to fill a software pipelined loop that includes the loop instructions 120 at the processor 102. Generally, the processor 102 may execute each loop iteration in a pipelined manner as multiple successive pipeline stages that may be performed concurrently at multiple execution units (not shown). For example, when the processor 102 executes the loop instructions 120 in a software pipelined loop that has a depth of three pipeline stages, the predicate counter 124 may be initialized to a value of three. An example of a software pipelined loop having a depth of three pipeline stages is depicted in FIG. 3.

The hardware loop control logic circuit 104 may further be adapted to detect a loop iteration condition at the processor 102 and to modify the predicate counter 124 for each iteration of the loop. For example, the predicate counter 124 may hold an initialization value that is successively decremented in response to the hardware loop control logic circuit 104 until the value of the predicate counter 124 reaches a reference value. The reference value may correspond to a value of the predicate counter 124 when the software pipelined loop is fully pipelined, where all instructions of the software loop process data that is not invalid due to pipeline dependencies. For example, where a later operation uses data produced by an earlier operation within a loop iteration, and the loop is pipelined so that the earlier operation is performed at a first pipeline stage and the later operation is performed at a later pipeline stage that is executed concurrently with the first pipeline stage, the dependency of the later pipeline stage on data produced at the first pipeline stage will cause the later pipeline stage to process invalid data until the data produced at the first pipeline stage is received at the later pipeline stage. To illustrate, a processor can execute loop instructions “A=A+1” and “store A to memory” at separate execution units, but the “store A to memory” instruction will store invalid results until data from the first “A=A+1” instruction has been received.

The predicate set logic circuit 108 may be adapted to set a predicate value stored at the predicate logic circuit 110 in response to detecting a value of the predicate counter 124. In a particular embodiment, the predicate set logic circuit 108 includes comparison logic circuitry (not shown) to perform a comparison between a value at the predicate counter 124 and the reference value. When the value at the predicate counter 124 is detected to have a value equal to the reference value, the predicate set logic circuit 108 may be configured to automatically set a predicate value stored at the predicate logic circuit 110. For example, the predicate logic circuit 110 may be initialized to store a false condition, the predicate counter 124 may be initialized to a number of pipeline stages of the software pipelined loop, and the reference value may be zero. When the predicate counter 124 is decremented to zero, the predicate set logic circuit 108 may automatically change the predicate value at the predicate logic circuit 110 to a true condition. The true condition of the predicate value stored at the predicate logic circuit 110 may be provided to the conditionally executed loop instruction 122 to affect processing of the loop instructions 120 at the processor 102. As another example, the predicate counter 124 may be set to zero and the reference value may be set to the number of pipeline stages of the software pipelined loop, and the predicate counter 124 may be incremented in response to each loop iteration.

Thus, loop initialization and loop control at the processor 102 may be performed by hardware elements including the hardware loop control logic circuit 104, latches or other devices to store the loop control values 106, to implement the predicate set logic circuit 108. By using hardware to implement loop control logic for a software pipelined loop, software loops may be encoded in a compact form where pipelined loop stages used to initialize the software pipeline, referred to as the prolog, may be replaced with one or more conditionally executed loop instructions 122, working in conjunction with the hardware of the system 100.

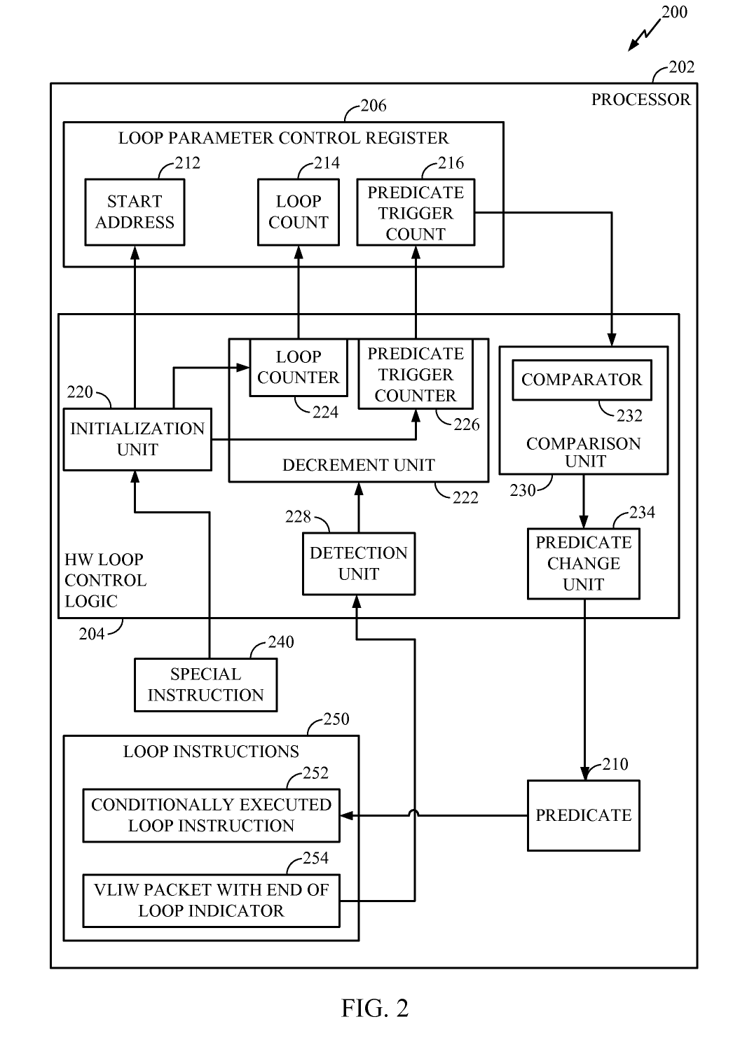

Referring to FIG. 2, a second illustrative embodiment of a loop control system is depicted and generally designated 200. The system 200 includes a processor 202, a hardware loop control logic circuit 204, and a loop parameter control register 206. The hardware loop control logic circuit 204 may correspond to the hardware loop control logic circuit 104 depicted in FIG. 1. Data stored at the loop parameter control register 206 may correspond to the loop control values 106 depicted in FIG. 1, and the processor 202 may correspond to the processor 102 depicted in FIG. 1.

In a particular embodiment, the loop parameter control register 206 includes a start address register 212 storing data representing a starting address of a software pipelined loop to be executed at the processor 202. The loop parameter control register 206 also includes a loop count register 214 that stores a loop count value corresponding to the software pipelined loop. The loop parameter control register 206 further includes a predicate trigger count register 216 storing a predicate trigger count value associated with the software pipelined loop to be executed at the processor 202. Generally, the loop parameter control register 206 is responsive to control inputs received from the hardware control logic circuit 204.

In a particular embodiment, the hardware loop control logic circuit 204 includes an initialization unit 220, a decrement unit 222, a comparison unit 230, a detection unit 228, and a predicate change unit 234. The initialization unit 220 may be responsive to a special instruction 240 executed at the processor 202. The initialization unit 220 may be adapted to determine a starting address and to set a value at the start address register 212. The initialization unit 220 may further be adapted to set an initial value of a loop counter 224 of the decrement unit 222. The initialization unit 220 may also be adapted to set an initial value of a predicate trigger counter 226 of the decrement unit 222.

In a particular embodiment, the decrement unit 222 is responsive to the detection unit 228 to decrement a value of the loop counter 224 and the predicate trigger counter 226 in response to a control input from the detection unit 228 indicating a completion of a loop iteration at the processor 202. In particular, the loop counter 224 may be initialized to a total number of iterations of loop instructions 250 to be performed at the processor 202, and may be decremented in response to each loop iteration detected at the detection unit 228. In addition, the predicate trigger counter 226 may be initialized to a value corresponding to a number of execution cycles required to completely fill a pipeline of a software pipelined loop so that sequential pipeline stages are executed using valid data from previous stages. The predicate trigger counter 226 may be decremented in response to loop iterations detected by the detection unit 228. The loop counter 224 and the predicate trigger counter 226 may write values to the loop count register 214 and the predicate trigger count register 216, respectively, and may update the respective values in response to an operation of the decrement unit 222.

In a particular embodiment, the detection unit 228 is configured to detect an end-of-loop condition at the processor 202. For example, the detection unit 228 may include a parsing logic circuit to parse a very long instruction word (VLIW) packet 254 with an end-of-loop indicator at the processor 202. In a particular embodiment, the end-of-loop indicator includes a predetermined bit field having a specified value within the VLIW packet 254. When the end-of-loop indicator is detected, the detection unit 228 provides a control input to the decrement unit 222 to decrement one or both of the counters 224 and 226.

In a particular embodiment, the comparison unit 230 is responsive to a value stored at the predicate trigger count register 216. The comparison unit 230 may include a comparator 232 that is adapted to compare a value of the predicate trigger count register 216 to a reference value and to provide an output of the comparison to the predicate change unit 234. For example, in a particular embodiment, the reference value may be zero, and the comparison unit 230 may be configured to provide a zero value output to the predicate change unit 234 until the predicate trigger count register 216 has a zero or negative value. In a particular embodiment, the comparator 232 is adapted to automatically identify a transition from a one value to a zero value of the predicate trigger counter 226, such as via the predicate trigger count register 216.

In a particular embodiment, the predicate change unit 234 is responsive to the control signal received from the comparison unit 230 to set or to reset a predicate value stored at the predicate logic circuit 210. For example, the predicate change unit 234 may be configured to initialize a predicate value stored at the predicate logic circuit 210 to a false condition. When the predicate change unit 234 receives a control input from the comparison unit 230 that indicates that the value of the predicate trigger count register 216 equals the reference value, the predicate change unit 234 may set the predicate value at the predicate logic circuit 210 to a true value. The predicate change unit 234 may also be responsive to the initialization unit 220 to clear the predicate value stored at the predicate logic circuit 210 prior to an execution of loop instructions.

In a particular embodiment, the predicate logic circuit 210 may include one or more hardware components configured to store a logical true or false value. The predicate logic circuit 210 may be accessible to the processor 202 to be used in conjunction with executing the loop instructions 250.

In a particular embodiment, the processor 202 is configured to receive and to execute instructions associated with the software pipelined loop. In particular, the processor 202 is configured to execute a special instruction 240 that may designate initialization values and control values associated with a subsequent software pipelined loop. The initialization values and control values of the special instruction 240 may be detected by or provided to the hardware loop control logic circuit 204.

In addition, the processor 202 is configured to receive and to execute the loop instructions 250 as a software pipelined loop. For example, the processor 202 may be adapted to execute one or more of the loop instructions 250 in parallel, such as at multiple parallel execution units of the processor 202. In addition, the processor 202 may execute the loop instructions 250 as software pipelined instructions, such that a single iteration of the loop instructions 250 may be performed in various sequential pipeline stages at the processor 202.

In a particular embodiment, the loop instructions 250 include at least one conditionally executed loop instruction 252. The at least one conditionally executed loop instruction 252 is responsive to a predicate value stored at the predicate logic circuit 210 to determine a condition of execution. In a particular embodiment, the conditionally executed loop instruction 252 conditionally stores data based on a predicate value at the predicate logic circuit 210 so that values calculated before the predicate value is set to “true” are not stored. For example, the conditionally executed loop instruction 252 may include a write command to write data to a memory, such as to an output register (not shown), based on computations performed earlier in a current iteration of the loop instructions 250. Executing the conditionally executed loop instruction 252 before the loop is fully pipelined would write invalid data to the memory when the write is performed before the data generated by the earlier computations is received. Therefore, execution of the conditionally executed loop instruction 252 may be conditioned on a predicate value stored at the predicate logic circuit 210, where the predicate value stored at the predicate logic circuit 210 indicates a condition of the software pipelined loop corresponding to the loop instructions 250. To illustrate, the processor 202 can execute loop instructions “A=A+1” and “store A to memory,” but the “store A to memory” instruction will store invalid results until data from the first “A=A+1” instruction has been received. Therefore, the “store A to memory” instruction may be conditionally executed based on the predicate value that is initially set to “false” and changed to “true” when the first “A=A+1” instruction has been completed.

Referring to FIG. 3, a particular illustrative embodiment of processing a software pipelined loop is depicted and generally designated 300. Representative instruction pipeline stages 302, 304, 306, and 308 represent pipeline stages of a software pipelined loop. A predicate value 310 indicates a value at a predicate that is designated “P3” and that may be accessed by one or more of the instructions executed at the instruction pipeline stages 302-308. A hardware predicate loop counter 312 indicates a countdown value corresponding to the software pipelined loop. Values associated with each of the instruction pipeline stages 302-308, the predicate value 310, and the hardware predicate loop counter 312 are depicted for consecutive clock cycles, beginning with clock cycle 1 at a loop beginning time period, and proceeding to clock cycle 23 at a later time period. In a particular embodiment, each clock cycle corresponds to an execution cycle at a pipelined processor.

In an illustrative embodiment, the system 300 represents execution of the loop instructions 120 at the processor 102 depicted in FIG. 1, with the predicate value 310 reflecting the predicate value stored at the predicate logic circuit 110, and with the hardware predicate loop counter 312 corresponding to the predicate counter 124. In another illustrative embodiment, the system 300 represents execution of the loop instructions 250 at the processor 202 depicted in FIG. 2, with the predicate value 310 corresponding to a predicate value stored at the predicate logic circuit 210, and with the hardware predicate loop counter 312 corresponding to an output of the predicate trigger counter 226 stored at the predicate trigger count register 216.

In a particular embodiment, the software pipelined loop is initiated via a special instruction illustrated in an exploded view as a loop initialization instruction 330. The loop initialization instruction 330 includes an instruction name 334 having the form spNLoop, where “N” has a value of three. The loop initialization instruction 330 includes data fields that include program loop setup information. For example, the loop initialization instruction 330 includes a first data field 336 corresponding to a start address of a software loop. The loop initialization instruction 330 also has a second data field 338 corresponding to a loop count that indicates a number of iterations of the loop to be performed. The loop initialization instruction 330, when executed by a processor, may return an initial value corresponding to an initialization of a predicate, such as a value of the predicate P3 332, which corresponds to the predicate value 310.

Thus, the loop initialization instruction 330 may indicate a start address of an instruction of the loop, a number of iterations of the loop, and may further indicate, by a value of “N” in the name 334, an initial value of a hardware predicate loop counter 312. In the illustrated embodiment, the name sp3loop indicates an initial value of three at the hardware predicate loop counter 312. Other values of “N” may be used to indicate other initial values of the hardware predicate loop counter 312. As illustrative examples, “sp1Loop” may indicate an initial value of one, and “sp2Loop” may indicate an initial value of two. The initial value of the hardware predicate loop counter 312 may be set to prevent execution of conditional operations until the loop is sufficiently pipelined. In a particular embodiment, “N” may be a positive integer less than four and may indicate a prolog count or a number of loops of a program loop to execute before changing the predicate value 310.

After processing the software pipelined loop initialization instruction 330, the software pipelined loop begins, illustrated as including a VLIW packet having instructions labeled A, B, C, and D. The instructions A, B, C, and D may each be performed in parallel at the processor, such as at multiple execution units of a single processor. Furthermore, the instructions A, B, C, and D may be sequential in that instruction B may use data that is generated by instruction A. Similarly, instruction C may use data that is generated by instruction A, instruction B, or any combination thereof. Furthermore, instruction D may use data generated by any of instructions A, B, C, or any combination thereof. Instruction D may write data indicative of an output of each particular loop iteration to a memory. For example, instruction D may perform a computation using results from each of the operations A, B, and C, and may store a resulting value to an output register. Therefore, instruction D should not be executed until the software pipelined loop is fully pipelined so that each of instructions A, B, and C is sequentially executed before instruction D to ensure that the input to instruction D consists of valid values. Instructions that may be sequentially executed before the software pipeline is completely filled are generally designated as the prolog 320. The portion of the execution of the software pipeline loop where the pipeline is full is designated as the kernel 322. The portion of the software pipeline loop where a final execution of the first instruction has completed but other pipeline instructions have yet to be executed, is generally referred to as the epilog 324.

As illustrated, at clock cycle one, an initial value of “three” is stored at the hardware predicate loop counter 312. Similarly, the predicate value P3 310 is initialized to a value of false. The software loop begins with execution of instruction A for the first iteration of the loop. Instructions B, C, and D may also be executed in parallel with A, as will be performed in the kernel portion 322; however, because instructions B, C, and D may be dependent on data output from previous instructions, results of instructions B, C, and D in clock cycle one may be invalid. Further, when instruction D includes a write instruction to store data at a memory, instruction D should not be executed until the data to be written is valid data indicating an output of instructions A, B, and C of the first cycle. Therefore, instruction D may be conditionally executed based on the predicate value 310, illustrated as a shading of the pipeline stage indicating non-execution of the instruction in a particular clock cycle. Because the predicate value 310 is false, the conditional write instruction D in the fourth instruction pipeline stage 308 is not performed.

Continuing to clock cycle two, instruction B receives output from instruction A and is executed for the first iteration of the loop, indicated as B(1). Similarly, instruction A is executed using data associated with the second iteration of the loop, indicated as A(2). Instructions C and D may be executed; however, an input value and consequently an output of each of instructions C and D may be undefined due to a data dependency on prior instructions. As illustrated, in clock cycle 2, the hardware predicate loop counter is decremented from a value of “three” to a value of “two,” and the predicate value 310 remains false. Because the predicate value 310 is false, the conditional write instruction D in the fourth instruction pipeline stage 308 is not performed.

Continuing to clock cycle three, instruction C at the third instruction pipeline stage 306 is executed corresponding to the first iteration of the loop. Instruction B is executed at the second instruction pipeline stage 304 corresponding to the second iteration of the loop, and instruction A is executed at the first instruction pipeline stage 302 corresponding to a third iteration of the loop. The hardware predicate loop counter 312 is decremented from a value of “two” to a value of “one,” and the predicate value 310 remains false. Because the predicate value 310 is false, the conditional write instruction D is not performed.

At clock cycle four, the prolog portion 320 of the software loop has ended and the kernel portion 322 has begun. Generally, in the kernel portion 322, the software pipeline has been filled and each of the instruction pipeline stages 302-308 operates on valid data. The hardware predicate loop counter 312 is decremented to the value “zero,” indicating that the pipeline is full and that the prolog stage 302 is finished. In response to the hardware predicate loop counter 312 equaling “zero,” the predicate value 310 is set to a true condition. In a particular embodiment, the predicate value 310 is set by hardware logic circuitry that is configured to compare a value of the predicate loop counter 312 to a reference value, such as the comparator 232 depicted in FIG. 2.

From clock cycle four through clock cycle twenty, the loop remains in the kernel portion 322 of execution where the pipeline remains full and all pipeline stages 302-308 execute instructions in sequential order to accommodate data dependencies between the instructions. Because the predicate value 310 evaluates to true, all instructions including instruction D are performed during clock cycle four and continuing through clock cycle twenty. At clock cycle twenty-one, the epilog portion 324 begins where the first pipeline stage 302 has completed executing instruction A for all twenty loop iterations, but the remaining pipeline stages 304, 306, and 308 continue processing instructions associated with prior iterations of the software loop. For example, at clock cycle twenty one, execution of instruction B corresponds to iteration 20, instruction C corresponds to iteration 19, and instruction D corresponds to iteration 18. Therefore, at clock cycle twenty-one, instructions B, C, and D are executed but instruction A is not executed. At clock cycle twenty-two, instructions C and D are executed, but instructions A and B are not executed. At clock cycle twenty-three, instruction D is executed to complete the last iteration of the loop.

As illustrated, the prolog portion 320 and the kernel portion 322 may be performed using a single VLIW packet including instructions A, B, C, and D, where execution of instruction D is conditional based on the predicate value P3 310, and including an end of loop indicator, denoted as “{A, B, C, if (P3) D}:endloop.” Thus, kernel code (i.e., the VLIW packet including the instructions A, B, C, and D) is executed in both the prolog portion 320 and the kernel portion 322. As the pipeline is emptying during the epilog portion 324, epilog VLIW packets may be used, such as: {NOP, B, C, D}, {NOP, NOP, C, D}, and {NOP, NOP, NOP, D}, where NOP indicates no operation at a particular execution unit. Such epilog instructions ensure that earlier pipeline instructions do not access unauthorized portions of memory when executed beyond the last loop iteration. However, in another embodiment, the epilog portion 322 may instead perform the kernel instructions when one or more input data sources may be safely accessed outside loop boundaries, such as additional memory read operations that may be safely performed by the instruction A at clock cycles 21, 22, and 23.

Using a single VLIW packet for the prolog portion 320 and the kernel portion 322 enables the software loop to be executed using less memory than if special prolog instructions were executed to fill the pipeline. By initializing and decrementing the hardware predicate loop counter to correspond to non-zero values during the prolog portion 320 and to a zero value at the kernel portion 322 when the loop is fully pipelined, the predicate value 310 may be set to restrict execution of conditionally executed data dependent instructions, such as instruction D, to the kernel when the pipeline is full. Such software pipelined loop processing may be performed using the predicate logic circuit 110 and the predicate counter 124 in conjunction with the processor 102 of FIG. 1, or by using the predicate logic circuit 210, the predicate trigger counter 226, and the predicate trigger count register 216 in conjunction with the processor 202 depicted in FIG. 2

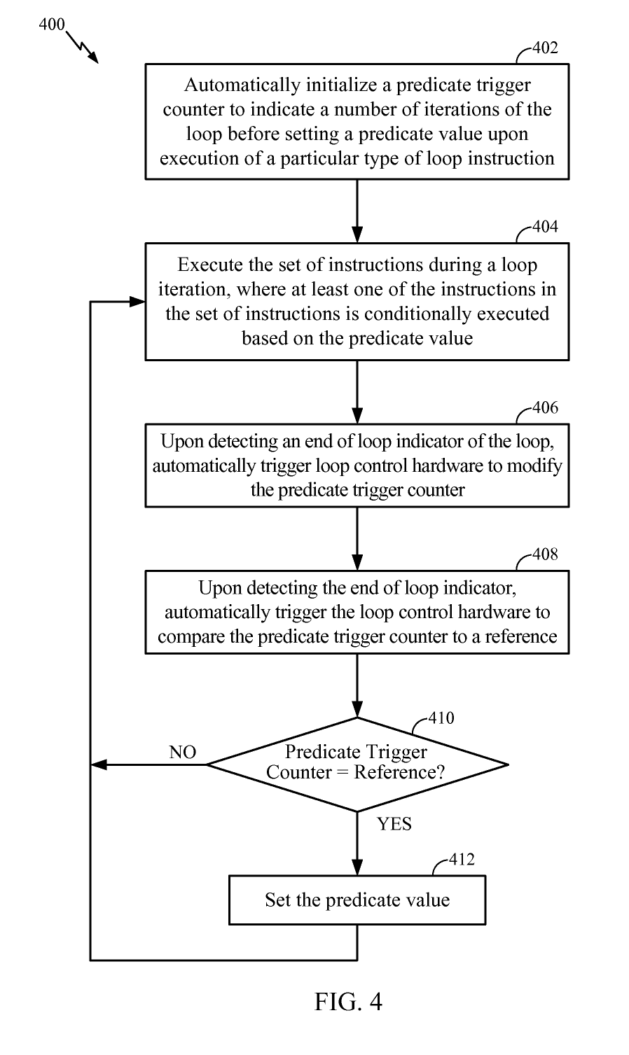

Referring to FIG. 4, a flow chart of a first illustrative embodiment of a loop control method is depicted and generally designated 400. In a particular embodiment, the method of processing a set of instructions in a loop 400 may be performed using one or more of the systems depicted in FIGS. 1 and 2. At 402, a predicate trigger counter is automatically initialized to indicate a number of iterations of the loop before setting a predicate value upon execution of a particular type of loop instruction. The set of instructions may be executed as a software pipelined loop, and the predicate trigger counter may be based on a number of pipeline stages of the software pipelined loop. In an illustrative embodiment, the particular type of loop instruction is the loop initialization instruction 330 depicted in FIG. 3.

Moving to 404, the set of instructions is executed during a loop iteration. At least one of the instructions in the set of instructions is conditionally executed based on the predicate value. For example, at least one of the instructions in the set of instructions that is conditionally executed may conditionally write data to an output register based on a predicate value.

Continuing to 406, upon detecting an end of loop indicator of the loop, loop control hardware modifying the predicate trigger counter is automatically triggered. For example, the loop control hardware may decrement the predicate trigger counter in response to detecting the end of loop indicator. Advancing to 408, upon detecting the end of loop indicator of the loop, the predicate trigger counter is compared to a reference to determine when to set the predicate value. In a particular embodiment, the reference is a zero value.

At decision 410, a determination is made whether the predicate trigger counter is equal to the reference. Where the predicate trigger counter is not equal to the reference, processing continues at 404 where the set of instructions is executed during a next loop iteration. Where the predicate trigger counter is equal to the reference, the predicate value is set, at 412, and processing returns to 404 where the set of instructions is executed during the next loop iteration.

Thus, execution of the conditionally executed instruction may be controlled by initializing the predicate trigger counter and setting the predicate in response to a comparison of the predicate trigger counter to the reference. Execution of a software pipelined loop without separate prolog and kernel instructions, such as depicted in FIG. 3, is therefore enabled and may be performed using the systems depicted in FIG. 1 and FIG. 2.

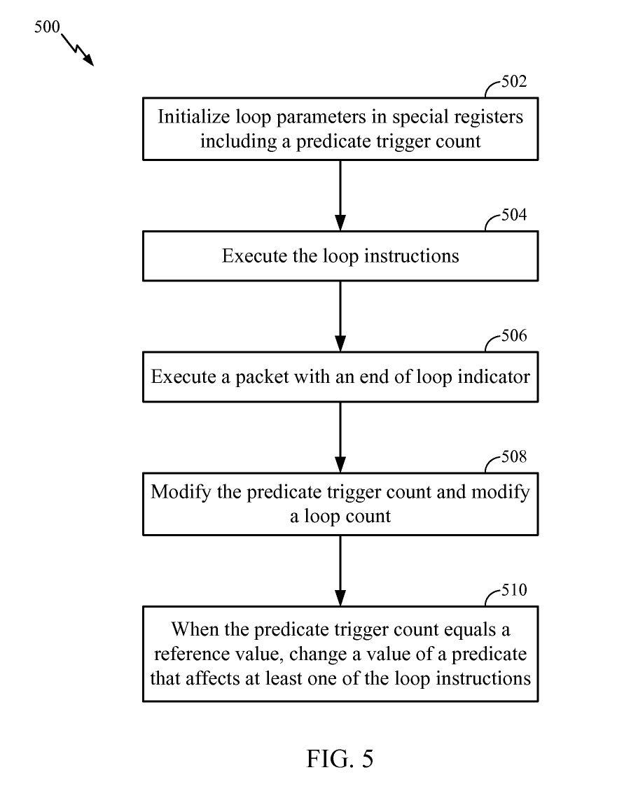

Referring to FIG. 5, a flow chart of a second illustrative embodiment of a loop control method is depicted and generally designated 500. In a particular embodiment, the method of processing loop instructions 500 may be performed using one or more of the systems depicted in FIGS. 1 and 2. At 502, loop parameters are initialized in special registers including a predicate trigger count. In a particular embodiment, a predicate value is initialized to a false condition, and the predicate trigger count corresponds to a pipeline depth of a software pipelined loop.

Proceeding to 504, the loop instructions are executed. In a particular embodiment, the loop instructions include kernel code but do not include prolog instructions. The kernel code may include a set of instructions of a software pipelined loop. Advancing to 506, an instruction having an end of loop indicator is executed. Moving to 508, the predicate trigger count is modified and a loop count is modified. Continuing to 510, when the predicate trigger count equals a reference value, a value of a predicate that affects at least one of the loop instructions is changed.

For example, the loop instructions may include at least one instruction that is conditionally executed based on the predicate. When the predicate trigger counter is initialized to a software pipeline depth, decrementing the predicate trigger count to equal reference value “zero” may indicate an end of a prolog portion of the software pipelined loop and a beginning of a kernel portion of the loop when the pipeline is filled. A conditionally executed instruction that is executed based on the predicate may therefore not be executed until the pipeline is filled. Thus, kernel instructions may also be executed in the prolog when the predicate is used to prevent execution of instructions that may generate harmful results before the pipeline is sufficiently filled.

The systems depicted in FIG. 1 and FIG. 2 provide examples of systems on which the method 500 may be performed. For example, the loop parameters may be initialized in the loop parameter control register 206 of FIG. 2, the loop count and predicated trigger count may be decremented by the decrement unit 222, and the value of the predicate 210 may be changed by the predicate change unit 234 of FIG. 2.

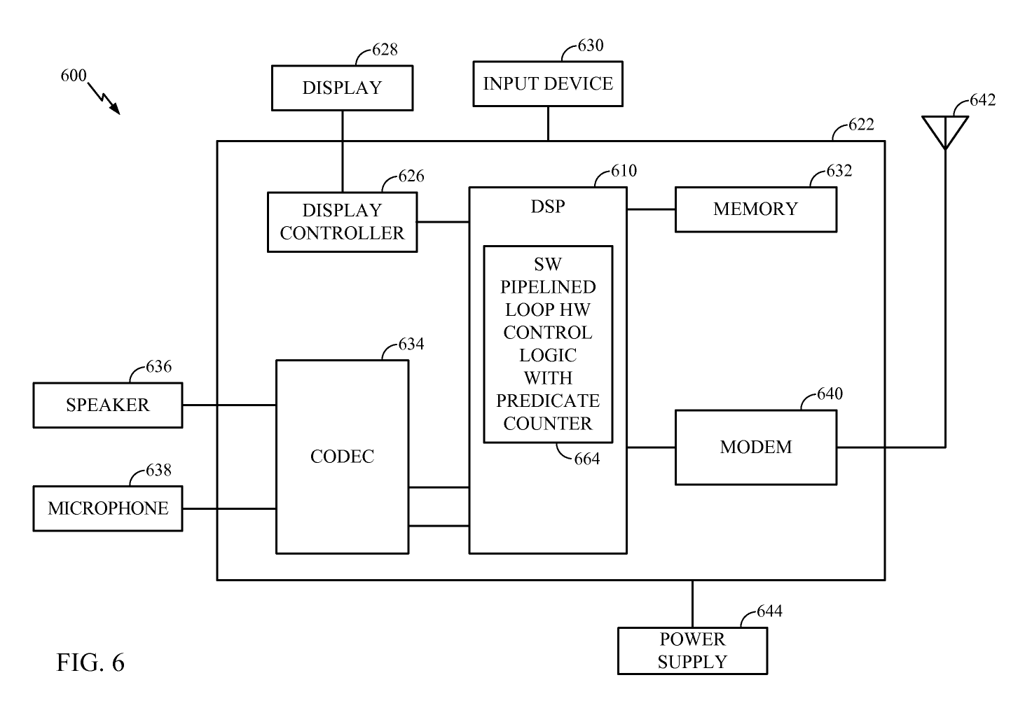

Referring to FIG. 6, a block diagram of a particular illustrative embodiment of a wireless processing device including a software pipelined loop hardware control logic circuit with a predicate counter 664 is depicted and generally designated 600. The device 600 includes a processor, such as a digital signal processor (DSP) 610, coupled to a memory 632. The software pipelined loop hardware control logic circuit with the predicate counter 664 may include one or more of the systems depicted in FIG. 1 and FIG. 2 and may operate in accordance with one or more of FIGS. 3-5, or any combination thereof. In an illustrative embodiment, the system 600 is a wireless phone.

FIG. 6 also shows a display controller 626 that is coupled to the digital signal processor 610 and to a display 628. A coder/decoder (CODEC) 634 can also be coupled to the digital signal processor 610. A speaker 636 and a microphone 638 can be coupled to the CODEC 634. A modem 640 can be coupled to the digital signal processor 610 and further coupled to a wireless antenna 642.

In a particular embodiment, the DSP 610, the display controller 626, the memory 632, the CODEC 634, and the modem 640 are included in a system-in-package or system-on-chip device 622. In a particular embodiment, an input device 630 and a power supply 644 are coupled to the on-chip system 622. Moreover, in a particular embodiment, as illustrated in FIG. 6, the display 628, the input device 630, the speaker 636, the microphone 638, the wireless antenna 642, and the power supply 644 are external to the system-on-chip device 622. However, each can be coupled to a component of the system-on-chip device 622, such as an interface or a controller.

During operation, the software pipelined loop hardware control logic with the predicate counter 664 may be used to enable efficient software pipelined loop processing at the digital signal processor 610. For example, the software pipelined loop hardware control logic circuit with the predicate counter 664 may include circuits or devices to detect a loop initialization instruction, an end of loop instruction, or both, at the digital signal processor 610, and may be operative to control a loop operation at the digital signal processor 610 by controlling values of one or more loop counters, such as a prolog counter, one or more predicates, or any combination thereof. Although depicted as included in the digital signal processor 610, the software pipelined loop hardware control logic circuit with the predicate counter 664 may be separate from one or more processors, such as at a control portion of the system-on-chip device 622. In general, the software pipelined loop may be implemented in any processor that has one or more parallel pipelines that enable instructions in the same software loop to be executed across the one or more parallel pipelines. Further, it will be understood that the device 600 may be any wireless processing device, such as a personal digital assistant (PDA), an audio player, an internet protocol (IP) phone, a cellular phone, a mobile phone, a laptop computer, a notebook computer, a template computer, any other system that may process a software pipelined loop, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method of processing a set of instructions in a loop, the method comprising:
automatically initializing a predicate trigger counter to indicate a number of iterations of the loop before setting a predicate value upon execution of a particular type of loop instruction;
executing the set of instructions during a loop iteration; and
upon detecting an end of loop indicator of the loop, automatically triggering loop control hardware to modify the predicate trigger counter and to compare the predicate trigger counter to a reference to determine when to set the predicate value and wherein at least one of the instructions in the set of instructions is conditionally executed based on the predicate value.

2. The method of claim 1, wherein the reference is a zero value and wherein the loop control hardware decrements the predicate trigger counter in response to the end of loop indicator.

3. The method of claim 1, wherein the at least one of the instructions in the set of instructions that is conditionally executed writes data to an output register.

4. The method of claim 3, wherein the set of instructions is executed as a software pipelined loop, and wherein the predicated trigger counter is based on a number of pipeline stages of the software pipelined loop.

5. A method of processing loop instructions, the method comprising:
initializing loop parameters in special registers including a predicate trigger count;
executing the loop instructions;
executing an instruction with an end of loop indicator;
modifying the predicate trigger count and modifying a loop count; and
when the predicate trigger count equals a reference value, changing a value of a predicate that affects execution of at least one of the loop instructions.

6. The method of claim 5, wherein the loop instructions include kernel code but the loop instructions do not include prolog instructions.

7. The method of claim 6, wherein the kernel code comprises a set of instructions of a software pipelined loop.

8. The method of claim 5, wherein the reference value equals zero, and wherein the predicate trigger count and the loop count are decremented in response to executing the instruction with the end of loop indicator.

9. The method of claim 5, wherein the loop instructions include at least one instruction that is conditionally executed based on the predicate.

10. The method of claim 9, wherein the loop instructions include kernel code but the loop instructions do not include prolog instructions.

11. An apparatus comprising:
a predicate count register to store a predicate trigger count;
an initialization logic circuit to initialize loop parameters of a program loop;
a processor to execute loop instructions of the program loop and to execute a packet including an end of loop indicator;
a logic circuit to modify the predicate trigger count and to modify a loop count of the program loop;
a comparison logic circuit to compare the predicate trigger count to a reference value; and
a logic circuit to change a value of a predicate that affects at least one instruction in the program loop based on a result of the comparison.

12. The apparatus of claim 11, wherein the initialization logic circuit clears the predicate prior to execution of the loop instructions.

13. A hardware loop control logic circuit comprising:
a detection unit to detect an end of loop indicator of a program loop;
a decrement unit to decrement a loop count and to decrement a predicate trigger counter; and
a comparison unit to compare the predicate trigger counter to a reference to determine when to set a predicate value.

14. The hardware loop control logic circuit of claim 13, wherein the program loop includes at least one instruction that is conditionally executable based on the predicate value.

15. A system comprising:
a hardware loop control logic circuit comprising:
a detection unit to detect an end of loop indicator of a program loop;
a decrement unit to decrement a loop count and to decrement a predicate trigger counter; and
a comparison unit to compare the predicate trigger counter to a reference to determine when to set a predicate value; and
a processor that executes a special instruction that triggers execution of the hardware loop control logic circuit.

16. The system of claim 15, wherein the special instruction comprises an spNloop type instruction where N is a positive integer less than four and where N indicates the number of loops of the program loop to execute before changing the predicate value.

17. The system of claim 16, wherein upon execution of the spNloop type instruction, values are calculated prior to the predicate value being set and the calculated values are not stored.

18. The system of claim 16, wherein the spNloop type instruction includes a data field that includes program loop setup information.

19. The system of claim 18, wherein the detection unit is configured to parse a very long instruction word (VLIW) packet to detect the end of loop indicator, wherein the decrement unit includes a counter to automatically decrement the predicate trigger counter when the end of loop indicator is detected, and wherein the comparison unit includes a comparator to automatically identify a transition from a one value to a zero value of the predicate trigger counter.

20. The system of claim 16, wherein the spNloop type instruction is used in connection with a software pipeline loop application.

21. The system of claim 17, wherein the processor is a very long instruction word (VLIW) type processor that includes the hardware loop control logic circuit and wherein multiple instructions in the program loop are executed in parallel by the processor.

22. The system of claim 18, wherein N identifies a prolog count.

23. The system of claim 16, wherein at least one instruction of the program loop conditionally stores data based on the predicate value.
